(19) United States
(12) Patent Application Publication
(10) Pub. No.: US 2024/0061186 A1
(43) Pub. Date: Feb. 22, 2024

(54) DIRECTION INDEPENDENT TWO-WAY MULTICORE FIBER OPTIC CABLE ASSEMBLIES AND CONNECTOR INTERFACES

(71) Applicant: Corning Research & Development Corporation, Corning, NY (US)

(72) Inventor: Qi Wu, Painted Post, NY (US)

(21) Appl. No.: 18/226,444

(22) Filed: Jul. 26, 2023

Related U.S. Application Data
(60) Provisional application No. 63/399,423, filed on Aug. 19, 2022.

(51) Int. Cl. G02B 6/38; G02B 6/02

(52) U.S. Cl. CPC G02B 6/3873; G02B 6/02042

(57) ABSTRACT

Fiber optic cable assemblies, connectors, and methods of making same. A fiber optic cable assembly includes a plurality of multicore optical fibers and is terminated by connectors that define the ends of the cable assembly. Each connector includes a connector interface having an interface axis of symmetry, and each multicore optical fiber includes a front end face having an end face core pattern and a back end face having an end face core pattern that is a mirror image of the front end face core pattern. Each connector is configured so that the front end face of one multicore optical fiber and the back end face of the other multicore optical fiber are placed in the connector interface to define a connector core pattern having mirror-image symmetry about the interface axis of symmetry. Core polarity is thereby maintained between fiber segments without regard to the direction of the cable assembly.

### PRIORITY APPLICATION

This application claims the benefit of priority of U.S. Provisional Application No. 63/399,423, filed on Aug. 19, 2022, the content of which is relied upon and incorporated herein by reference in its entirety.

### TECHNICAL FIELD

This disclosure relates generally to fiber optic connectors and cable assemblies, and more particularly, to multicore fiber optic connectors and cable assemblies that provide direction-independent connectivity, and methods of making multicore fiber optic connectors and cable assemblies that provide direction-independent connectivity.

### BACKGROUND

Optical fibers are useful in a wide variety of applications, the most common being as part of the physical layer of a communication protocol through which network nodes communicate over a data network. Benefits of optical fibers include wide bandwidth and low noise operation. Continued growth of the Internet has resulted in a corresponding increase in demand for network capacity. This demand for network capacity has, in turn, generated a need for increased bandwidth between network nodes.

Multicore optical fibers are optical fibers in which multiple cores are contained within a common cladding. Multicore optical fibers function essentially as a bundle of single-core fibers, thereby providing increased capacity as compared to individual single-core optical fibers. The use of multicore optical fibers has yet to be widely adopted for long haul applications due to advances in technology that have enabled increased transmission rates over existing single-core optical fibers, such as dense wavelength division multiplexing and coherent optical communication techniques. Nevertheless, with the rapid growth of hyperscale datacenters, and the maturing of dense wavelength division multiplexing and coherent optical communication technologies, the use of multicore fiber optic cables is expected to increase.

Datacenter campuses provide computing spaces for housing computer systems and associated network components. These computing spaces are typically spread across multiple buildings located on the campus. To facilitate connections between these computing spaces, conduits or other cable ducts configured to carry fiber optic cables are typically installed between the computing spaces when the datacenter campus is constructed. The distances between computing spaces within a datacenter campus are typically less than two kilometers, and massive numbers of optical fibers are used to interconnect these spaces both within each campus as well as between regional campuses. Preexisting cable ducts between computer spaces have a limited amount of space that is difficult to expand. Accordingly, as the need for higher fiber counts continues to increase, multicore optical fibers have the potential to provide a solution to this limited amount of cable duct space.

FIGS. 1A and 1B depict exemplary multicore optical fibers 10 each representing a separate fiber span. Each multicore optical fiber 10 includes a cladding 12, a plurality of cores 14a-14d contained within the cladding 12, a front end face 16, a back end face 18, and a fiber draw direction extending from the front end face 16 to the back end face 18, as indicated diagrammatically by single-headed arrows 20. The cores 14a-14d are spaced symmetrically around a center axis of the cladding 12, and each end face 16, 18 includes a marker 22 that identifies a reference core (e.g., core 14a) of the multicore optical fiber 10. In FIG. 1A, the multicore optical fibers 10 are oriented so that the fiber draw direction of each fiber span is in the same direction. In FIG. 1B, the multicore optical fibers 10 are oriented so that their fiber draw directions are in opposite directions.

In order to maintain a consistent core polarity between connected fiber spans, the multicore optical fibers 10 must be oriented so that they have the same fiber draw direction. In the depicted case, core polarity is maintained when the front end face 16 of one multicore optical fiber 10 interfaces with the back end face 18 of another multicore optical fiber. As shown by FIG. 1A, matching fiber draw directions enable the end faces 16, 18 to be coupled such that each core 14a-14d on the front end face 16 is aligned with a correspondingly positioned core 14a-14d on the back end face 18. Core polarity can thereby be maintained across multiple fiber spans that have matching fiber draw directions.

In contrast, when the multicore optical fibers 10 of two spans are oriented so that they have opposing fiber draw directions as in FIG. 1B, two like end faces (e.g., two back end faces 18) need to be interfaced. With the exemplary multicore optical fibers 10 of FIGS. 1A and 1B, fiber spans having opposite fiber draw directions can at best be connected such that the optical fibers are cross-connected. This cross-connection results in an optical beam entering a specific core (e.g., core 14a) of one span being emitted from a different core (e.g., core 14b) of the other fiber span.

FIGS. 2A and 2B depict another variation of the exemplary multicore optical fibers 10 in which the cores 14a-14d are arranged in an asymmetrical pattern. Specifically, one core (e.g., core 14a) is radially offset relative to the other cores (e.g., cores 14b-14c). This asymmetrical arrangement enables individual cores 14a-14d to be identified without the need for a marker 22. As with the fiber spans depicted by FIG. 1A, the multicore optical fibers 10 depicted by FIG. 2A are oriented so that they have the same fiber draw direction. This enables the end faces 16, 18 to be coupled such that each core 14a-14d on the front end face 16 is aligned with a corresponding core 14a-14d on the back end face 18. Core polarity can thereby be maintained across the fiber spans of FIG. 2A. In contrast, the multicore optical fibers 10 depicted by FIG. 2B are oriented so that they have opposing fiber draw directions. This prevents the end faces 16, 18 from being coupled in a way that maintains either polarity or connectivity across the fiber spans of FIG. 2B.

As can be seen from FIGS. 1A-2B, in order to distinguish each core in a multicore optical fiber, radial symmetry of the core pattern must be broken. Radial symmetry may be broken by introducing a marker 22 in parallel with the cores 14a-14d, as illustrated in FIGS. 1A and 1B, or by positioning at least one of the cores 14a-14d so that the core 14a-14d is in an “off position” (e.g., a radially non-symmetric position), as illustrated by FIGS. 2A and 2B. The marker 22 or off position core 14a may be observed in any cross section of the multicore optical fiber 10. By designating the off position/marked core as a reference core, the rest of the cores can be identified through a naming convention. In other words, the core polarity of a multicore optical fiber may be defined by including at least one core with a mark-based or position-based asymmetry. A core polarity defined in this way is maintained regardless of the observer's viewpoint. Asymmetric core patterns look different at the front and back end faces 16, 18 of the multicore optical fiber 10 because each core pattern as viewed at one end face is a mirror-image of the core pattern as viewed at the other end face. The resulting directional nature of multicore optical fibers connectivity is both profoundly different from a single core optical fiber and a source of connectivity issues.

Duplex patch cord cable assemblies are widely used in datacenter networks as part of a structured cabling system for connecting network nodes using single core optical fibers. For example, duplex transceivers are typically connected via duplex patch cords to cassettes or harnesses, which may then be connected to a trunk cable through a Multi-fiber Push On (MPO) connector. Because the receive port of each transceiver is connected to the transmission port of the other receiver, an optical fiber polarity switch typically occurs at some point between the transceivers being connected.

TIA-568 is a technical standard issued by the Telecommunications Industry Association (TIA), and defines three methods (methods A, B, and C) for connecting transceivers using structured cabling. Method A uses straight-through MPO terminated trunk cables in which a fiber polarity switch occurs in the duplex patch cords on one side. Methods B and C use what is referred to as A-to-B type or “straight-through” duplex cables, with polarity switching occurring at the MPO trunks. The multitude of options in single core fiber based structured cabling leads to significant complexity when migrating to multicore fiber. With multicore fiber, in addition to managing the optical fiber polarity, one must also trace the path of each core in each multicore optical fiber. The use of multicore optical fibers therefore adds a new dimension of complexity to connections between nodes in fiber optic networks.

FIGS. 3A-3C depict exemplary fiber optic cables 24 (“cables 24”) each including a plurality of multicore optical fibers 10 (e.g., two multicore optical fibers 10) arranged in a configuration suitable for use in an A-to-B type duplex cable assembly. Each multicore optical fiber 10 is configured as described above for FIGS. 1A-2B, and each cable 24 represents a separate fiber span 26, 28. Because the cables 24 in FIG. 3A have the same draw directions, both the multicore optical fibers 10 of each span, and the cores 14a-14b of each multicore optical fiber 10, can be aligned to maintain core polarity.

FIG. 3B depicts the effects of a change in the draw direction of the cable 24 of lower fiber span 28 so that the draw directions of the cables 24 are in opposite directions. As can be seen, the multicore optical fibers 10 of the upper fiber span 26 are no longer aligned with the corresponding multicore optical fibers 10 of the lower fiber span 28. That is, multicore optical fiber A of the upper fiber span 26 is aligned with multicore optical fiber B of the lower fiber span 28, and multicore optical fiber B of the upper fiber span 26 is aligned with multicore optical fiber A of the lower fiber span 28. In addition, the cores within each multicore optical fiber 10 do not have matching core polarities. Specifically, core 1 of each upper multicore optical fiber 10 is aligned with core 2 of its respective lower multicore optical fiber 10, core 2 of each upper multicore optical fiber 10 is aligned with core 1 of its respective lower multicore optical fiber 10, core 3 of each upper multicore optical fiber 10 is aligned with core 4 of its respective lower multicore optical fiber 10, and core 4 of each upper multicore optical fiber 10 is aligned with core 3 of its respective lower multicore optical fiber 10.

FIG. 3C depicts the effects rotating the cable 24 of lower fiber span 28 180 degrees about its longitudinal axis in an attempt to correct the polarity of the multicore optical fibers 10. Although rotating the cable 24 of lower fiber span 28 brings each multicore optical fiber 10 into alignment with its respective multicore optical fiber 10 in the upper fiber span 26 (i.e., A→A and B→B) the polarities of the cores 14a-14d remain mismatched. Specifically, core 1 of each upper multicore optical fiber 10 is aligned with core 3 of its respective lower multicore optical fiber 10, core 2 of each upper multicore optical fiber 10 is aligned core 4 of its respective lower multicore optical fiber 10, core 3 of each upper multicore optical fiber 10 is aligned with core 1 of its respective lower multicore optical fiber 10, and core 4 of each upper multicore optical fiber 10 is aligned with core 2 of its respective lower multicore optical fiber 10. Thus, it should be apparent that it is not possible to maintain core polarity across spans of conventional fiber optic cables 24 having opposite draw directions which include multicore optical fibers 10.

In order for an optical beam coupled into a specific core at one end of a multicore optic fiber to emerge from the corresponding core at the opposite end of a fiber optic link including multiple fiber spans, core polarity must be maintained across each fiber span of the fiber optic link. This leads to a requirement that multicore fiber spans in a multi-span fiber optic link have the same fiber draw direction. This consistent fiber draw direction requirement means that multicore fiber spans with opposite fiber draw directions cannot be connected to provide a multi-span fiber optic link. In cases of symmetrically positioned multi-core arrangements, this leads to cross-connected signals in which optical beams coupled to one core emerge from a different core at the other end of the multi-span fiber optic link. In cases of asymmetrically positioned multicore arrangements, connecting the same end of each multicore optical fiber to each other leads to both core polarity mismatches and an inability to couple the optical beam across the fiber span for at least some of the cores.

When cable assemblies including multicore fibers are deployed as part of a structured cabling solution in hyperscale datacenters, the difficulties in managing core polarities of thousands of multicore optical fibers become intractable. Maintaining all multicore optical fiber spans so that they are directionally aligned is impractical at best, as it entails both tedious tracking of the cable ends and a requirement that network components have two types of multicore connector interfaces so that they are compatible with both the front and back ends of the multicore optical fibers.

In order to take advantage of the increased bandwidth provided by multicore optical fibers, cable assemblies will need to manage the direction dependent connectivity requirements of multicore optical fibers to maintain core polarity between network nodes. Thus, there is a need in the fiber optic industry for improved fiber optic cable configurations that include multicore optical fibers, as well as methods of making such cables, that maintain core polarity between fiber spans.

### SUMMARY

In an aspect of the disclosure, an improved fiber optic cable assembly is disclosed. The fiber optic cable assembly includes a first connector, a second connector, a first multicore optical fiber, and a second multicore optical fiber. The first connector defines a first end of the fiber optic cable assembly, and includes a first connector interface having a first interface axis of symmetry. The second connector defines a second end of the fiber optic cable assembly, and includes a second connector interface having a second interface axis of symmetry. The first multicore optical fiber includes a first front end face having a front end face core pattern and a first back end face having a back end face core pattern that is a mirror image of the front end face core pattern. The second multicore optical fiber includes a second front end face having the front end face core pattern and a second back end face having the back end face core pattern. The first connector is configured so that the first front end face of the first multicore optical fiber and the second back end face of the second multicore optical fiber are placed in the first connector interface to define, at least in part, a first connector core pattern having mirror-image symmetry about the first interface axis of symmetry. The second connector is configured so that the first back end face of the first multicore optical fiber and the second front end face of the second multicore optical fiber are each placed in the second connector interface to define, at least in part, a second connector core pattern having mirror-image symmetry about the second interface axis of symmetry, wherein the first connector core pattern and the second connector core pattern are the same.

In an embodiment of the disclosed fiber optic cable assembly, the first connector includes a first alignment key that defines an orientation of the first connector, and the second connector includes a second alignment key that defines the orientation of the second connector.

In another embodiment of the disclosed fiber optic cable assembly, the first connector interface includes a first key-axis that is aligned with the first alignment key, the second connector interface includes a second key-axis that is aligned with the second alignment key, the first interface axis of symmetry is parallel to the first key-axis, and the second interface axis of symmetry is parallel to the second key axis.

In another embodiment of the disclosed fiber optic cable assembly, the first connector interface includes the first key-axis that is aligned with the first alignment key, the second connector interface includes the second key-axis that is aligned with the second alignment key, the first interface axis of symmetry is orthogonal to the first key-axis, and the second interface axis of symmetry is orthogonal to the second key axis.

In another embodiment of the disclosed fiber optic cable assembly, the front end face core pattern has mirror-image symmetry about a fiber axis of symmetry in each of the first front end face and the second front end face, and the back end face core pattern has mirror-image symmetry about the fiber axis of symmetry in each of the first back end face and the second back end face.

In another embodiment of the disclosed fiber optic cable assembly, the first interface axis of symmetry divides the first connector interface into a first side and a second side thereof, the second interface axis of symmetry divides the second connector interface into a first side and a second side thereof, the first side of the first connector interface has the same position relative to the first interface axis of symmetry as the first side of the second connector interface relative to the second interface axis of symmetry, the second side of the first connector interface has the same position relative to the first interface axis of symmetry as the second side of the second connector interface relative to the second interface axis of symmetry, the first front end face of the first multicore optical fiber is on the first side of the first connector interface, the second back end face of the second multicore optical fiber is on the second side of the first connector interface, the first back end face of the first multicore optical fiber is on the second side of the second connector interface, and the second front end face of the second multicore optical fiber is on the first side of the second connector interface.

In another embodiment of the disclosed fiber optic cable assembly, the first interface axis of symmetry divides the first connector interface into the first side and the second side thereof, the second interface axis of symmetry divides the second connector interface into the first side and the second side thereof, the first side of the first connector interface has the same position relative to the first interface axis of symmetry as the first side of the second connector interface relative to the second interface axis of symmetry, the second side of the first connector interface has the same position relative to the first interface axis of symmetry as the second side of the second connector interface relative to the second interface axis of symmetry, the first front end face of the first multicore optical fiber is on the first side of the first connector interface, the second back end face of the second multicore optical fiber is on the second side of the first connector interface, the first back end face of the first multicore optical fiber is on the first side of the second connector interface, and the second front end face of the second multicore optical fiber is on the second side of the second connector interface.

In another embodiment of the disclosed fiber optic cable assembly, the fiber axis of symmetry of each of the first front end face and the second back end face is orthogonal to the first interface axis of symmetry, and the fiber axis of symmetry of each of the first back end face and the second front end face is orthogonal to the second interface axis of symmetry.

In another embodiment of the disclosed fiber optic cable assembly, the fiber axis of symmetry of each of the first front end face and the second back end face is parallel to the first interface axis of symmetry, and the fiber axis of symmetry of each of the first back end face and the second front end face is parallel to the second interface axis of symmetry.

In another aspect of the disclosure, an improved method of making a fiber optic cable assembly is disclosed. The method includes providing the first multicore fiber, the second multicore fiber, the first connector including the first connector interface having the first interface axis of symmetry, and the second connector including the second connector interface having a second interface axis of symmetry. The first multicore optical fiber includes the first front end and the first back end, the first front end including the first front end face having the front end face core pattern and the first back end including the first back end face having the back end face core pattern that is the mirror image of the front end face core pattern. The second multicore optical fiber includes the second front end and the second back end, the second front end including the second front end face having the front end face core pattern and the second back end including the second back end face having the back end face core pattern. The method further includes coupling the first front end of the first multicore optical fiber and the second back end of the second multicore optical fiber to the first connector, coupling the first back end of the first multicore optical fiber and the second front end of the second multicore optical fiber to the second connector, placing the first front end face of the first multicore optical fiber and the second back end face of the second multicore optical fiber in the first connector interface to define, at least in part, the first connector core pattern having mirror-image symmetry about the first interface axis of symmetry, and placing the first back end face of the first multicore optical fiber and the second front end face of the second multicore optical fiber in the second connector interface to define, at least in part, the second connector core pattern having mirror-image symmetry about the second interface axis of symmetry, wherein the first connector core pattern and the second connector core pattern are the same.

In an embodiment of the disclosed method, the method further includes providing the first alignment key to the first connector that defines the orientation of the first connector, and providing the second alignment key to the second connector that defines the orientation of the second connector.

In another embodiment of the disclosed method, the method further includes defining the first key-axis of the first connector interface that is aligned with the first alignment key, and defining the second key-axis of the second connector interface that is aligned with the second alignment key such that the first interface axis of symmetry is parallel to the first key-axis, and the second interface axis of symmetry is parallel to the second key axis.

In another embodiment of the disclosed method, the method further includes defining the first key-axis of the first connector interface that is aligned with the first alignment key, and defining a second key-axis of the second connector interface that is aligned with the second alignment key such that the first interface axis of symmetry is orthogonal to the first key-axis, and the second interface axis of symmetry is orthogonal to the second key axis.

In another embodiment of the disclosed method, the method further includes configuring the first and second multicore optical fibers so that the front end face core pattern has mirror-image symmetry about the fiber axis of symmetry in each of the first front end face and the second front end face, and the back end face core pattern has mirror-image symmetry about the fiber axis of symmetry in each of the first back end face and the second back end face.

In another embodiment of the disclosed method, the first interface axis of symmetry divides the first connector interface into the first side and the second side thereof, the second interface axis of symmetry divides the second connector interface into the first side and the second side thereof, the first side of the first connector interface has the same position relative to the first interface axis of symmetry as the first side of the second connector interface relative to the second interface axis of symmetry, the second side of the first connector interface has the same position relative to the first interface axis of symmetry as the second side of the second connector interface relative to the second interface axis of symmetry, and the method further includes placing the first front end face of the first multicore optical fiber in the first connector interface so that the first front end face is on the first side of the first connector interface, placing the second back end face of the second multicore optical fiber in the first connector interface so that the second back end face is on the second side of the first connector interface, placing the first back end face of the first multicore optical fiber in the second connector interface so that the first back end face is on the second side of the second connector interface, and placing the second front end face of the second multicore optical fiber in the second connector interface so that the second front end face is on the first side of the second connector interface.

In another embodiment of the disclosed method, the first interface axis of symmetry divides the first connector interface into the first side and the second side thereof, the second interface axis of symmetry divides the second connector interface into the first side and the second side thereof, the first side of the first connector interface has the same position relative to the first interface axis of symmetry as the first side of the second connector interface relative to the second interface axis of symmetry, the second side of the first connector interface has the same position relative to the first interface axis of symmetry as the second side of the second connector interface relative to the second interface axis of symmetry, and the method further includes placing the first front end face of the first multicore optical fiber in the first connector interface so that the first front end face is on the first side of the first connector interface, placing the second back end face of the second multicore optical fiber in the first connector interface so that the second back end face is on the second side of the first connector interface, placing the first back end face of the first multicore optical fiber in the second connector interface so that the first back end face is on the first side of the second connector interface, and placing the second front end face of the second multicore optical fiber in the second connector interface so that the second front end face is on the second side of the second connector interface.

In another embodiment of the disclosed method, the method further includes placing each of the first front end face and the second back end face in the first connector interface so that the fiber axis of symmetry of each of the first front end face and the second back end face is orthogonal to the first interface axis of symmetry, and placing each of the first back end face and the second front end face in the second connector interface so that the fiber axis of symmetry of each of the first back end face and the second front end face is orthogonal to the second interface axis of symmetry.

In another embodiment of the disclosed method, the method further includes placing each of the first front end face and the second back end face in the first connector interface so that the fiber axis of symmetry of each of the first front end face and the second back end face is parallel to the first interface axis of symmetry, and placing each of the first back end face and the second front end face in the second connector interface so that the fiber axis of symmetry of each of the first back end face and the second front end face is parallel to the second interface axis of symmetry.

In another aspect of the disclosure, an improved fiber optic connector is disclosed. The fiber optic connector includes the connector interface having the interface axis of symmetry, the front end face of the first multicore optical fiber, and the back end face of the second multicore optical fiber. The front end face of the first multicore optical fiber includes the front end face core pattern, and the back end face of the second multicore optical fiber includes the back end face core pattern that is the mirror image of the front end face core pattern. The front end face of the first multicore optical fiber and the back end face of the second multicore optical fiber are placed in the connector interface so that the front end face and the second back end face define, at least in part, a connector core pattern having mirror-image symmetry about the interface axis of symmetry.

In an embodiment of the disclosed fiber optic connector, the front end face core pattern has mirror-image symmetry about the fiber axis of symmetry of the front end face, and the back end face core pattern has mirror-image symmetry about the fiber axis of symmetry of the back end face.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIGS. 1A and 1B are perspective views of exemplary multicore optical fibers having a reference core identified by a marker and showing the effects of draw direction on core polarity.

FIGS. 2A and 2B are perspective views of exemplary multicore optical fibers having a reference core identified by being in an off position and showing the effects of draw direction on core polarity.

FIGS. 3A-3C are perspective views of exemplary ribbons each including a plurality of multicore optical fibers and showing the effects of draw direction on core polarity.

FIG. 4 is a schematic view of a multicore fiber optic cable assembly including a plurality of multicore optical fibers each having a front end face and a back end face.

FIG. 5 is a schematic view of an exemplary multicore A-to-B duplex patch cord including two 2×2 multicore optical fibers in a parallel configuration.

FIGS. 6 and 7 are schematic views of exemplary multicore A-to-B duplex patch cords each including two 2×2 multicore optical fibers in an anti-parallel configuration.

FIG. 8 is a schematic view of an exemplary multicore A-to-B duplex patch cord including two of the duplex patch chords from FIG. 6 with connectors ganged together to form a quadruplex cable connector.

FIGS. 9-11 are schematic views of exemplary multicore A-to-B duplex patch cords each including two 1×4 multicore optical fibers in an anti-parallel configuration.

FIGS. 12-16 are schematic views of exemplary multicore A-to-A duplex patch cords each corresponding to a respective multicore A-to-B duplex patch cord of one of FIGS. 6, 7 and 9-11.

FIG. 17 is a schematic view of an exemplary multicore optical fiber loopback device including a single 2×2 multicore optical fiber.

FIG. 18 is a schematic view of an exemplary structured cabling system that includes a plurality of A-to-B duplex patch cords.

FIG. 19 is a perspective view of an exemplary fiber optic cable assembly including connectors at each end in which multicore optical fibers are arranged relative to each other so that the core pattern has a mirror-image symmetry at both ends of the fiber optic cable assembly.

FIG. 20 is an end view of one of the connectors of the fiber optic cable assembly of FIG. 19.

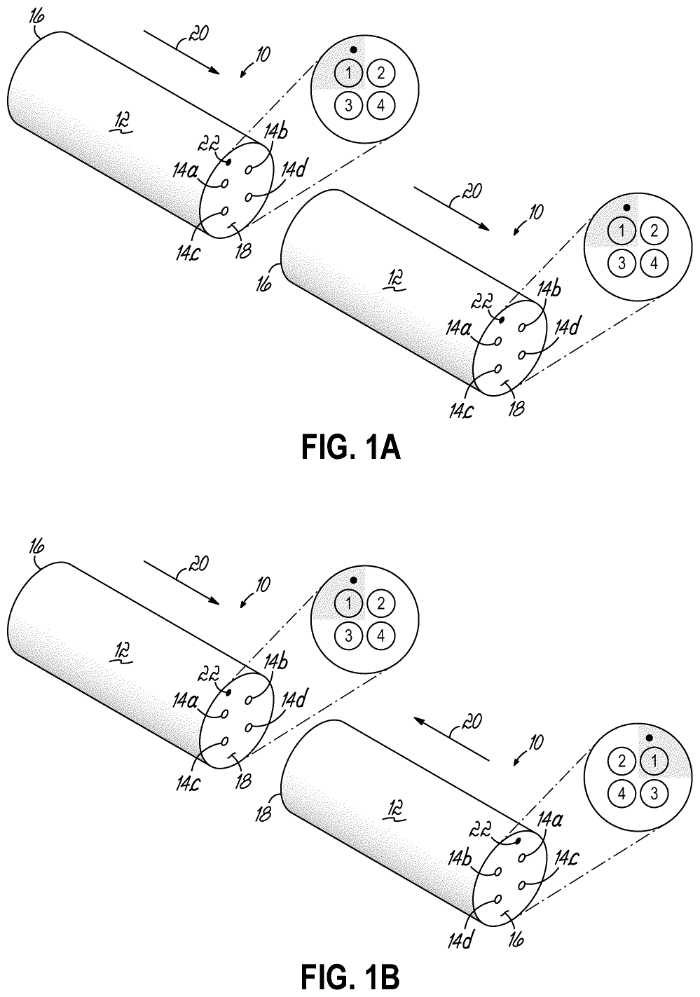

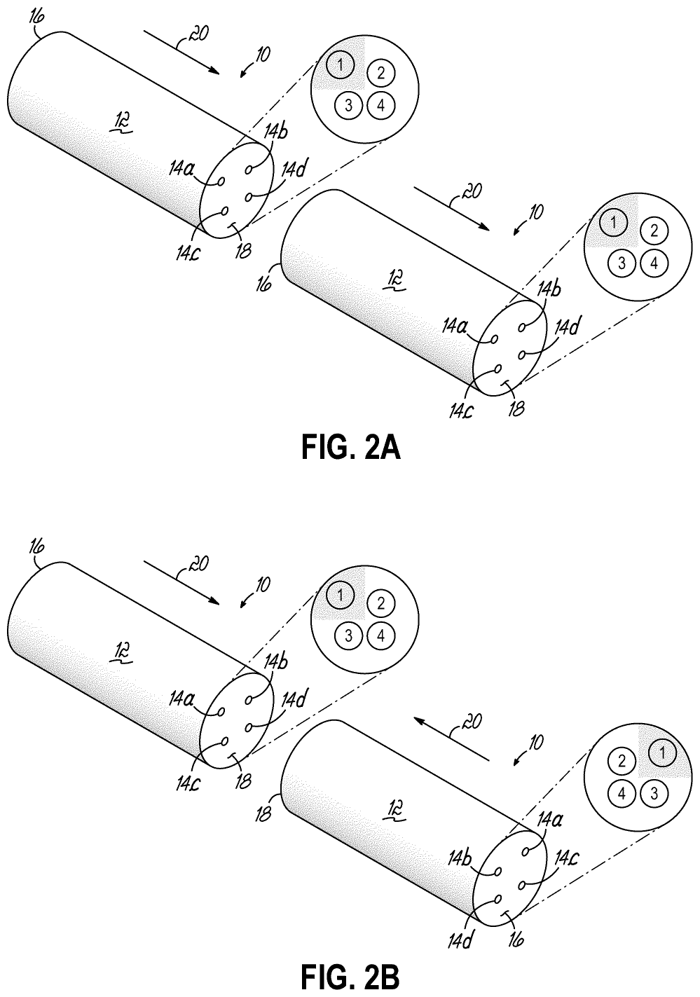

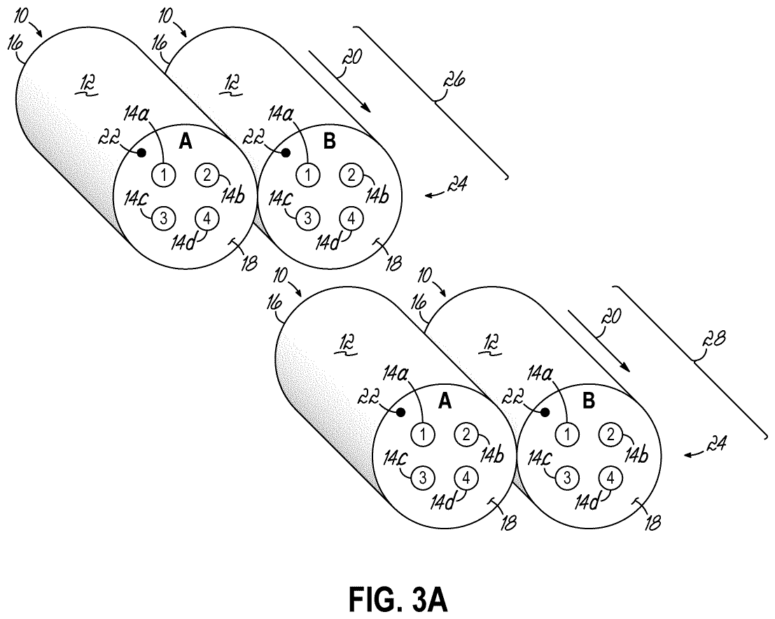

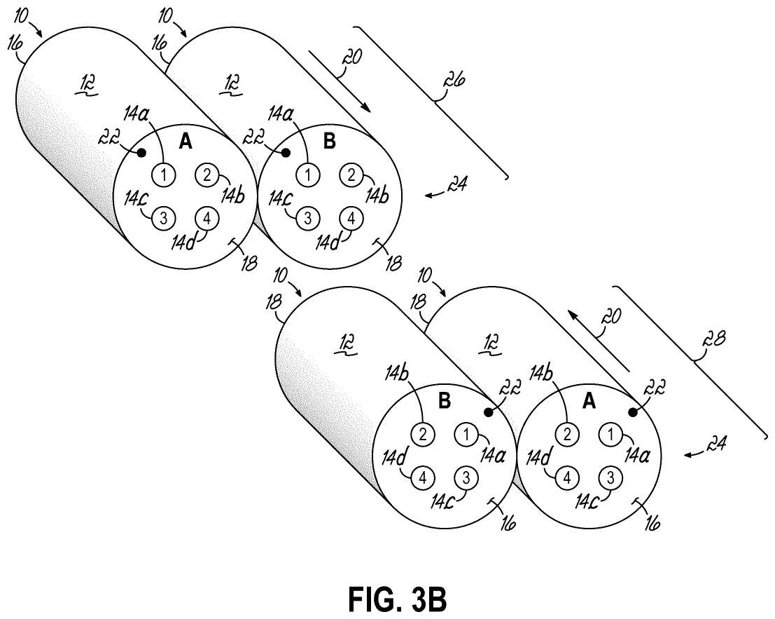

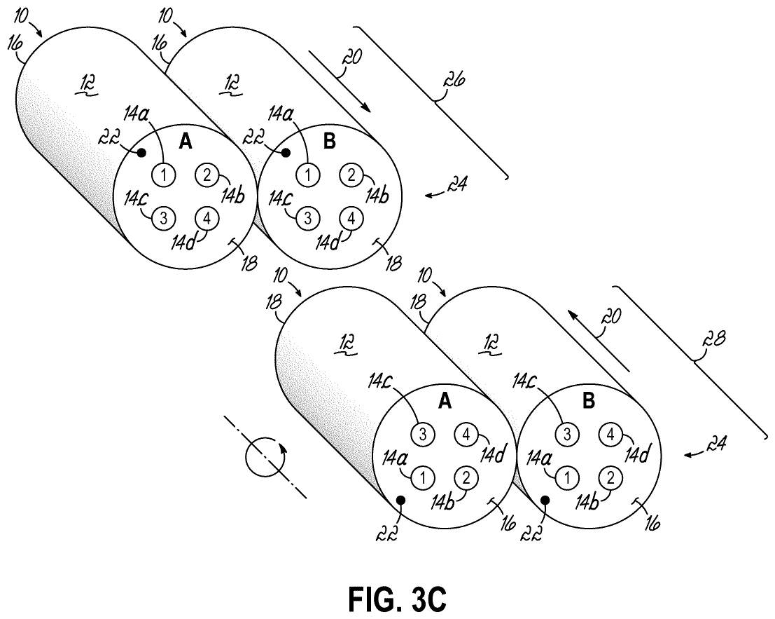

### DETAILED DESCRIPTION

Various embodiments will be further clarified by the examples described below. In general, the below description relates fiber optic cable assemblies and other fiber optic components including one or more fiber optic connectors, which may also be referred to as “optical connector”, or simply “connector”. The connectors include an anti-parallel multicore optical fiber arrangement that provides a connector core pattern having mirror-image symmetry at the connector interface. The connector core pattern is the pattern of the cores in the multicore fiber arrangement, at the connector interface. Thus, the connector core pattern is defined by the placement of the end faces of the multicore optical fibers in the connector interface. Placement of the end faces refers to selecting both the position and orientation of each end face in the connector interface such that the core pattern of each end face provides a portion of the desired connector core pattern.

The front and back end faces of each of the multicore optical fibers are operatively coupled to respective front and back connectors such that the fiber optic cable assembly may be used as a full duplex patch cord. The terms “front” and “back” are merely used in this disclosure in a relative sense to distinguish between different ends of an element (e.g., a multicore optical fiber, a cable assembly, etc.). The disclosed patch cords provide a structured multicore optical fiber cabling system that maintains consistent core polarity between network nodes at both the connector and optical fiber level. Aspects of the disclosure may be applied, but are not limited, to duplex LC connectors (e.g., according to IEC 61754-20: 2012) and very-small form factor (VSFF) dual-ferrule connectors such as CS, SN, or MDC-type connectors (e.g., each according to the Quad Small Form Factor Pluggable Double Density Multi Source Agreement hardware specification revision 6.3 and the documents referred to therein). VSFF dual-ferrule connectors include two single-fiber ferrules within a common housing. Corresponding connector interfaces for network components such as transceivers and cassettes (also referred to as “modules”) are also disclosed.

The above general statements may be better understood when considering the definitions of terms used in the statement. With respect to multicore optical fibers having a draw direction due to an asymmetric end face core pattern (see Background section above), the term “anti-parallel” refers to at least two of such multicore optical fibers being terminated by one or more connectors, but having opposite draw directions at each connector. And finally, term “mirror-image symmetry” refers to there being intended symmetry of the connector core pattern and/or fiber end face core pattern about an axis of symmetry of the connector interface and/or fiber end face that is: a) in a plane orthogonal to a longitudinal axis of the connector and/or optical fiber, and b) bisects the connector interface and/or fiber end face.

The mirror-image symmetry of the connector core patterns at the connector interfaces enables connections between fiber spans to maintain core polarity independent of the direction of the cable assemblies being connected. Cable assemblies and other fiber optic network components (e.g., transceivers, fan-in/fan-out devices, etc.) configured in accordance with the disclosed embodiments allow consistent core polarity mapping from one span to another independent of the cable direction, and thereby facilitate deployment of efficient structured multicore fiber optic cabling systems that include such fiber optic network components.

In particular, fiber optic network components of the present disclosure include anti-parallel multicore optical fibers. The anti-parallel multicore optical fibers may be arranged in the fiber optic network component in any manner that results in the connector interfaces thereof having mirror-image symmetry with regard to the connector core pattern. This mirror-image symmetry allows one fiber optic network component to be connected to another fiber optic network component by a cable assembly having the same mirror-image symmetry without regard to the direction of the cable assembly. As described in detail below, this bi-directional connectivity provides unique advantages over known arrangements.

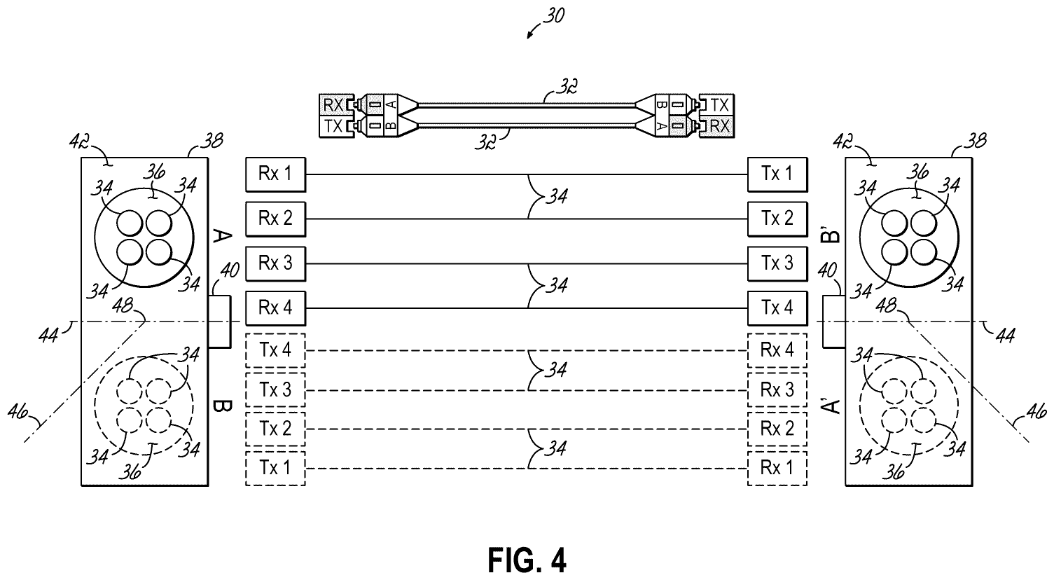

FIG. 4 depicts an exemplary fiber optic cable assembly 30 including a plurality of multicore optical fibers 32 (e.g., two multicore optical fibers 32) in a duplex arrangement. Each multicore optical fiber 32 includes a plurality of cores 34 (e.g., four cores in a 2×2 configuration) within a common cladding. Each end face 36 of each multicore optical fiber 32 is operatively coupled to a respective cable connector 38 including an alignment key 40. The cable connectors 38 are configured so that each core 34 can receive one or more optical signals from a transmitter port at one end of the multicore optical fiber 32 (generally referred to as the “B” end), and convey the one or more received optical signals to a receiver port at the other end of the multicore optical fiber 32 (generally referred to as the “A” end). Accordingly, the fiber optic cable assembly 30 may be referred to as an A-to-B duplex patch cord.

The fiber optic cable assembly 30 has an outward appearance similar to a standard A-to-B duplex patch cord. However, unlike a standard A-to-B duplex patch cord that uses single core optical fibers, the fiber optic cable assembly 30 is configured to maintain the core polarity of each multicore optical fiber 32 to avoid routing optical signals to the wrong destination. Maintaining core polarity enables each transmitter/receiver channel from one transceiver to be operatively coupled to its respective receiver/transmitter channel in the other transceiver. To this end, and as described in more detail below, the connectors 38 at each end of the fiber optic cable assembly 30 and connectors of the transceiver are configured to have a commonly defined multicore connector interface 42.

The cable connectors 38 may be characterized in that the end face core patterns are arranged to collectively define a pattern of cores 34 at the connector interface 42 which has mirror-image symmetry, i.e., symmetry about an interface axis of symmetry 44. The interface axis of symmetry 44 may be normal to a longitudinal axis 46 of the cable connector 38. The longitudinal axis 46 of cable connector 38 may be normal to the connector interface 42 and pass through the geometric center of the connector interface 42. That is, the longitudinal axis 46 of the cable connector 38 may be generally centered in and orthogonal to the connector interface 42. The intersection of the longitudinal axis 46 and connector interface 42 may define a center point 48 on the connector interface 42 through which the interface axis of symmetry 44 passes.

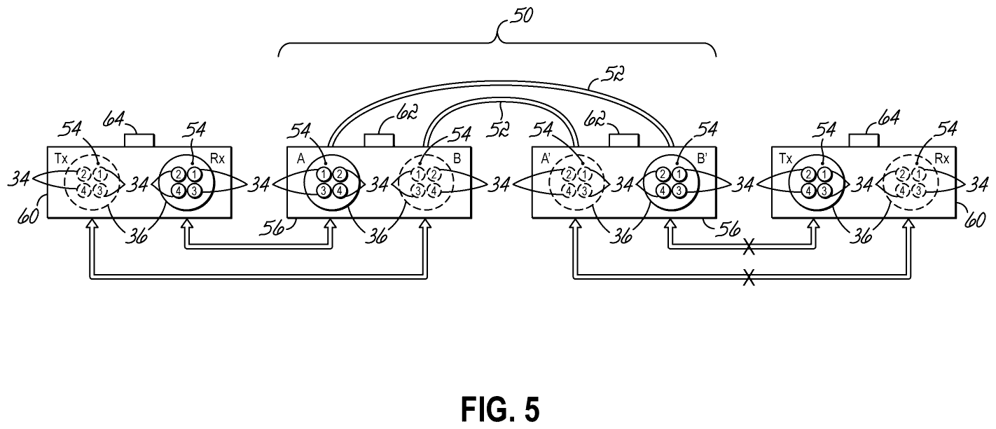

To provide an example of how a multicore A-to-B duplex patch cord can be directionally sensitive, FIG. 5 depicts an exemplary multicore A-to-B duplex patch cord 50 including two multicore optical fibers 52 each having the same draw direction. Each exemplary multicore optical fiber 52 includes four cores 34 in a 2×2 configuration and a marker 54. The marker 54 defines an asymmetry in the core pattern of each multicore optical fiber 52. This asymmetry allows the identity of each core 34 of the multicore optical fiber 52 to be determined based on the position of the core 34 relative to a reference core 34, e.g., the core nearest the marker 54. For example, once the reference core 34 is identified, the remaining cores 34 may be identified based on a predetermined naming convention for the cores 34. Although the core pattern asymmetry is depicted in this and the following examples as being provided by the marker 54, it should be understood that a core pattern asymmetry can also be provided by arranging the cores in an asymmetric pattern within each individual multicore optical fiber, e.g., by using an off position reference core.

The patch cord 50 is terminated at each end by a cable connector 56, and is depicted as connecting a pair of exemplary transmit/receive port connectors 60 each corresponding to a respective network component, such as a transceiver (not shown). The cable connectors 56 and port connectors 60 include respective alignment keys 62, 64 that ensure the connectors 56, 60 are connected in a predetermined orientation with respect to each other. Although the exemplary alignment keys 62, 64 are depicted as being on the outer surface of the connectors 56, 60, it should be understood that other ways of ensuring consistent connection orientations may be used, such as connector markings, keyed shapes, or internal alignment keys. Accordingly, aspects of the present disclosure are not limited to any particular type of connector keying, or the use of connectors having keys.

For purposes of illustration only, and to facilitate identification by the reader, the end face 36 of each multicore optical fiber 52 in FIG. 5, as well as the multicore optical fibers in subsequent figures, is depicted with a letter (e.g., “A” or “B”), and each core 34 is depicted with a number (e.g., “1”, “2”, “3” or “4”, with the reference core being depicted by number “1”). In addition, solid and dashed lines may be used to identify signal paths as they are coupled between connectors.

Due to the directionality of the multicore optical fibers 52, the connector core patterns are different at each end of the patch cord 50. The connector core pattern of a standardized port connector 60 can therefore only match one end of the patch cord 50. In the present example, the core polarity of the cable connector 56 on the A/B end of patch cord 50 matches that of the port connector 60 to which it is to be connected. That is, when mated, each core 34 of each multicore optical fiber 52 of cable connector 56 is aligned with a correspondingly numbered core 34 of the port connector 60.

In contrast, the core polarity of the cable connector 56 on the A′/B′ end of patch cord 50 does not match that of the port connector 60 to which it is to be connected. Thus, when mated, each core 34 of each multicore optical fiber 52 in the cable connector 56 is aligned with a differently numbered core 34 of the port connector 60. Specifically, for each end face 36, core 1 in the cable connector 56 is aligned with core 2 in the port connector 60, core 2 in the cable connector 56 is aligned with core 1 in the port connector 60, core 3 in the cable connector 56 is aligned with core 4 in the port connector 60, and core 4 in the cable connector 56 is aligned with core 3 in the port connector 60. Accordingly, the connection on the right side of the figure is incorrect, as indicated by the “X” through each double-headed arrow.

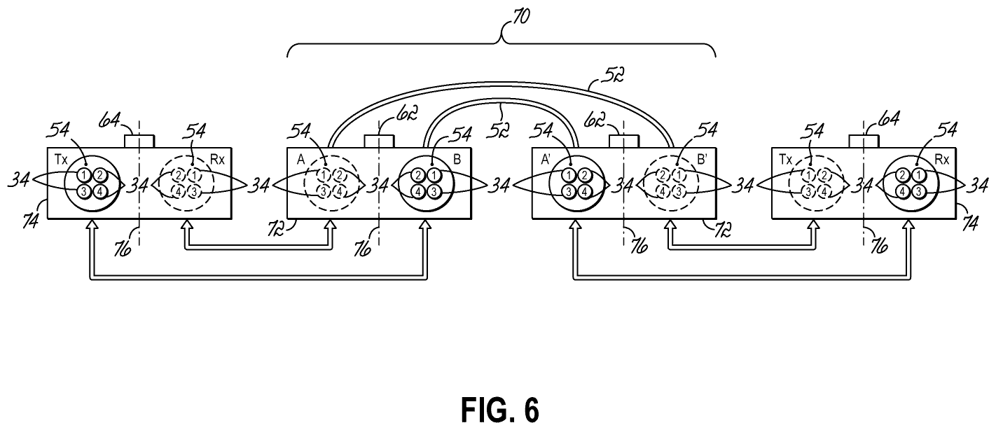

FIG. 6 depicts another exemplary multicore A-to-B duplex patch cord 70 including two 2×2 multicore optical fibers 52 that have opposite draw directions and which are terminated by cable connectors 72. Arranging multicore optical fibers 52 having the same core pattern asymmetry in an anti-parallel configuration provides mirror-image symmetry to the core pattern of connector 72. The cable connectors 72 are depicted as connecting a pair of exemplary transmit/receive port connectors 74. Each of the connectors 72, 74 has a key-axis 76 that bisects the connector 72, 74 and is aligned with (i.e., passes through) the alignment key 62, 64 thereof.

By virtue of the opposing draw directions and symmetric positioning of the end faces 36 with respect to the key-axis 76, the connector core patterns in both the cable connectors 72 and port connectors 74 have mirror-image symmetry about the key-axis 76. Thus, the key-axis 76 is colinear with the interface axis of symmetry for the connector interface 42 of cable and port connectors 72, 74. As a result of this mirror-image symmetry, the connector core pattern is the same at each end of the multicore A-to-B duplex patch cord 70 (i.e., the “A” end has the same connector core pattern as the “B” end). This allows the connector core pattern of the port connectors 74 to be standardized to that of the cable connector 72 so that core polarity matches at both ends of the A-to-B duplex patch cord 70. Thus, exemplary multicore A-to-B duplex patch cord 70 is non-directional.

The connectors 72, 74 may be duplex LC, CS, SN, or MDC connectors, or any other suitable connector, consistent with general statements about this disclosure at the beginning of this Detailed Description section. The marker 54 may be oriented in other angles as long as the end faces 36 of the multicore optical fibers 52 are oriented to provide mirror-image symmetry of the connector core pattern about the key-axis 76. In practice, it may be desirable to standardize the orientation of the markers 54 with respect to the connector interface 42 to facilitate multi-vendor interoperability. For example, the markers 54 could be standardized as being oriented parallel to a key up direction.

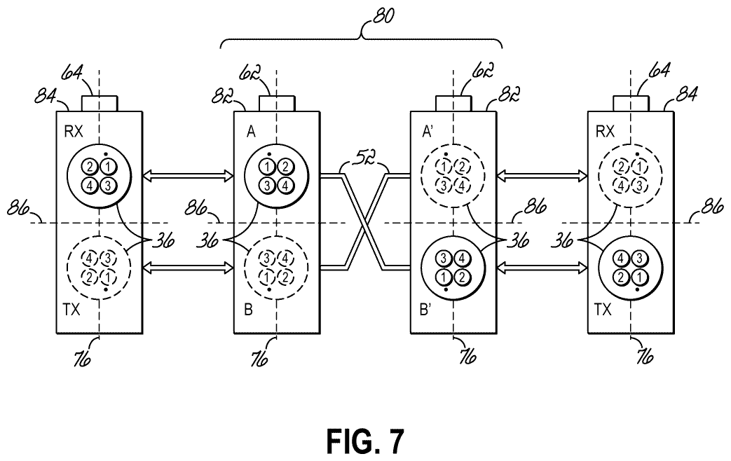

FIG. 7 depicts another exemplary multicore A-to-B duplex patch cord 80 including two 2×2 multicore optical fibers 52 in an anti-parallel configuration. The multicore optical fibers 52 are terminated by cable connectors 82, which are depicted as connecting a pair of exemplary transmit/receive port connectors 84. The connectors 82, 84 are configured so that the end faces 36 of multicore optical fibers 52 are centered on a plane that includes the key-axis 76 of the connector 82, 84 (i.e., a common plane including the key axis 76 extends through the end faces 36).

The resulting connector core pattern of the connectors 82, 84 has mirror-image symmetry relative to a line of symmetry oriented orthogonally to the key-axis 76 and centered between the multicore optical fibers 52. This line of symmetry is colinear with a cross-axis 86 that bisects each connector 82, 84 along a plane perpendicular to the key-axis 76, and is thus orthogonal to the key-axis 76. Known connectors having this type of coplanar arrangement between the optical fibers and alignment key include MDC and SN-type duplex connectors set out in the Quad Small Form Factor Pluggable Double Density Multi Source Agreement hardware specification revision 6.3 and the documents referred to therein. Accordingly, a duplex MDC or SN interface for an optical component, such as a breakout module, fan-in/fan-out module, or a transceiver, can be defined following the connector core patterns depicted in FIG. 7.

Configuring the multicore A-to-B duplex patch cord 80 so that the multicore optical fibers 52 have opposite draw directions and placing the end faces 36 within the connectors 82, 84 so that the connector core patterns have mirror-image symmetry about the cross-axis 86 results in each end of the multicore A-to-B duplex patch cord 80 having the same core polarity (i.e., the same connector core pattern). This, in turn, enables connections to port connectors 84 having a consistent configuration without concerns regarding the direction of the patch cord 80.

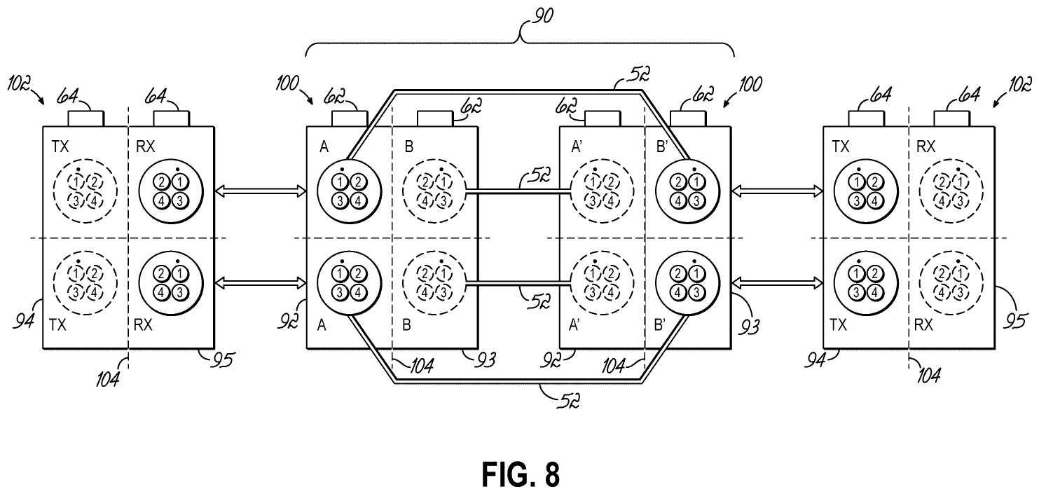

FIG. 8 depicts another exemplary multicore A-to-B duplex patch cord 90 including four 2×2 multicore optical fibers 52 in an anti-parallel configuration. At each end of the patch cord 90, the multicore optical fibers 52 are terminated in one of two cable connectors 92, 93 (e.g., VSFF dual-ferrule connectors) that are ganged together to form a quadruplex cable connector 100. The patch cord 90 is depicted as connecting a pair of transmit/receive quadruplex port connectors 102 each comprising a similarly ganged pair of port connectors 94, 95. The connector core pattern of each quadruplex connector 100, 102 has mirror-image symmetry about an interface axis of symmetry 104 that bisects the quadruplex connector 100, 102. The interface axis of symmetry 104 is considered as aligned with the alignment keys 62, 64 of connectors 92-95 (as opposed to orthogonal to the alignment keys 62, 64) because the interface axis of symmetry 104 is parallel to the key-axes 76 (not depicted) of the ganged connectors 92-95. It may be noted that the quadruplex connectors 100, 102 also have essentially the same connector core pattern as would be formed by vertically stacking the cable and port connectors 72, 74 depicted in FIG. 6. Advantageously, a quadruplex multicore fiber connector may provide an attractive solution for transceivers having eight lanes.

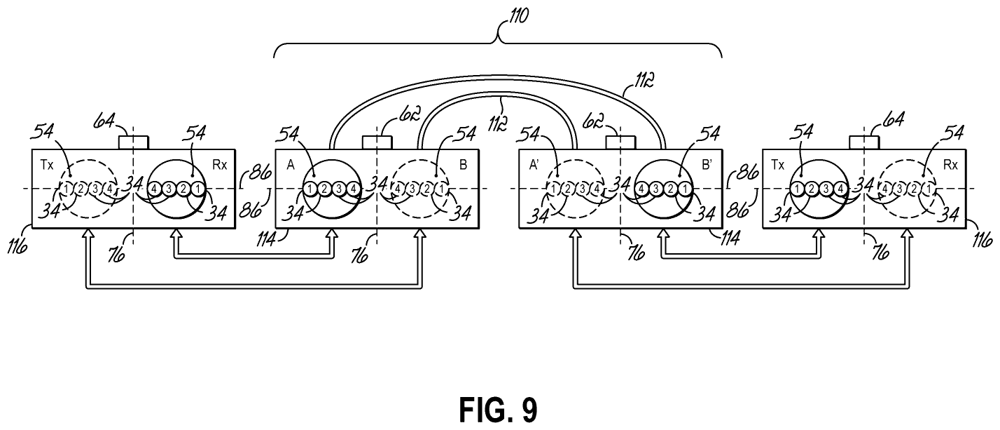

FIG. 9 depicts another exemplary multicore A-to-B duplex patch cord 110 including two 1×4 multicore optical fibers 112 in an anti-parallel configuration. At each end of the patch cord 110, the optical fibers 112 are terminated by a cable connector 114 which is depicted as connecting the patch cord 110 to exemplary transmit/receive port connectors 116. The connectors 114, 116 are configured to place each optical fiber 112 so that the cores 34 of the optical fibers 112 are aligned with the cross-axis 86 of the respective cable connector 114. The cores 34 of each multicore optical fiber 112 are thus colinearly aligned with the cores 34 of the other optical fiber 112 terminated by the same connector 114, 116. This core placement results in each connector core pattern having mirror-image symmetry about the key-axis 76 of the connector 114, 116 in question.

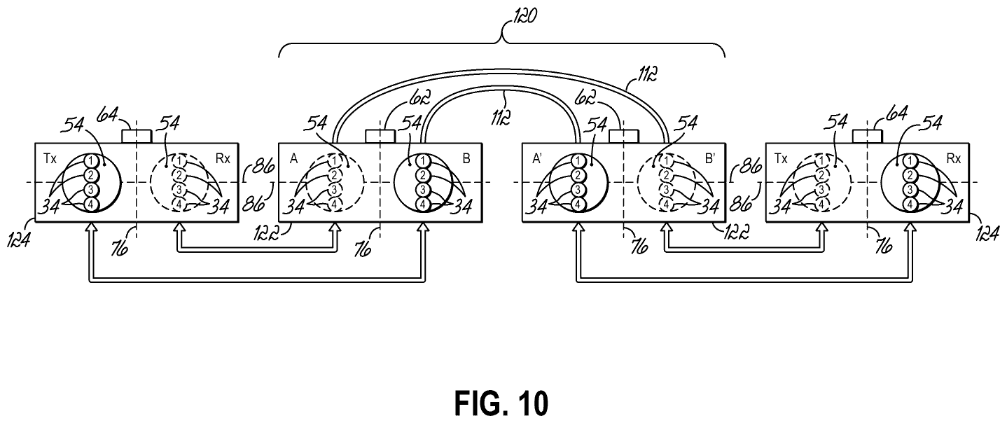

FIG. 10 depicts another exemplary multicore A-to-B duplex patch cord 120 including two 1×4 multicore optical fibers 112 having an anti-parallel configuration. At each end of the patch cord 120, the optical fibers 112 are terminated by a cable connector 122 which is depicted as connecting the patch cord 120 to exemplary transmit/receive port connectors 124. The connectors 122, 124 are configured to place each optical fiber 112 so that the cores 34 of the optical fibers 112 are parallel to the key-axis 76 of the respective connector 122, 124. This core placement results in each connector core pattern having mirror-image symmetry about the key-axis 76 of the connector 122, 124 in question.

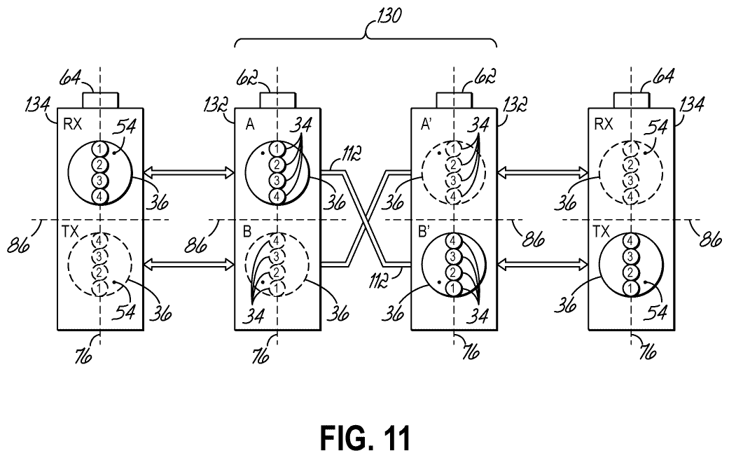

FIG. 11 depicts another exemplary multicore A-to-B duplex patch cord 130 including two 1×4 multicore optical fibers 112 having an anti-parallel configuration. At each end of the patch cord 130, the optical fibers 112 are terminated by a cable connector 132 which is depicted as connecting the patch cord 130 to exemplary transmit/receive port connectors 134. The connectors 132, 134 are configured to place the end face 36 of each optical fiber 112 so that the cores 34 of the optical fibers 112 are aligned with the key-axis 76 of the respective cable connector 114. This core placement results in each connector core pattern having mirror-image symmetry about the key-axis 76 of the connector 132, 134 in question. The optical fibers 112 are oriented within their respective connectors 132, 134 so that the connector core pattern also has mirror-image symmetry about the cross-axis 86 of the connector 132, 134.

The mirror-image symmetry of the end face core pattern of a multicore optical fiber having a 1×n core configuration may be utilized to provide more functions than other types of multicore optical fiber. For example, a 1×4 multicore optical fiber can be used directly for chip connectivity, thereby eliminating the need for fan-in/fan-out devices. However, relatively tight core spacing may cause the outer cores to be subject to higher attenuation as compared to other core configurations. Cross talk may also be higher than in 2×2 multicore optical fiber. Because 1×n multicore optical fibers can have end face core patterns with mirror-image symmetry, a single multicore optical fiber can provide two-way connectivity, and does not require end face core patterning that varies with fiber direction. By way of illustration, the following examples of multicore duplex patch cords including 1×n multicore optical fibers are depicted with an anti-parallel fiber layout. However, it should be recognized that due to the non-directional nature of 1×n multicore optical fibers, the depicted designs may also be implemented using parallel multicore optical fiber configurations.

Occasionally, the receive/transmit polarity of a fiber optic link may need to be reversed. The need to reverse receive/transmit polarity may occur, for example, if the signals are being routed between equipment having different connector polarities. In these cases, A-to-A duplex patch cords, sometimes referred to as cross-over patch cords, may be used. The optical fibers in A-to-A duplex patch cords are “crossed” so that the optical fiber polarity is reversed by the cable. As described below, this crossing may disrupt core polarity when reversing optical fiber polarity in a multicore A-to-A duplex patch cord.

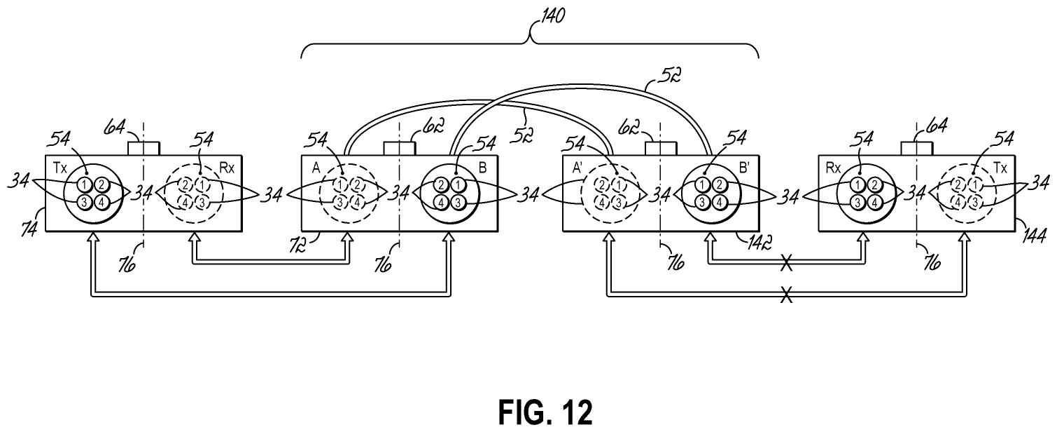

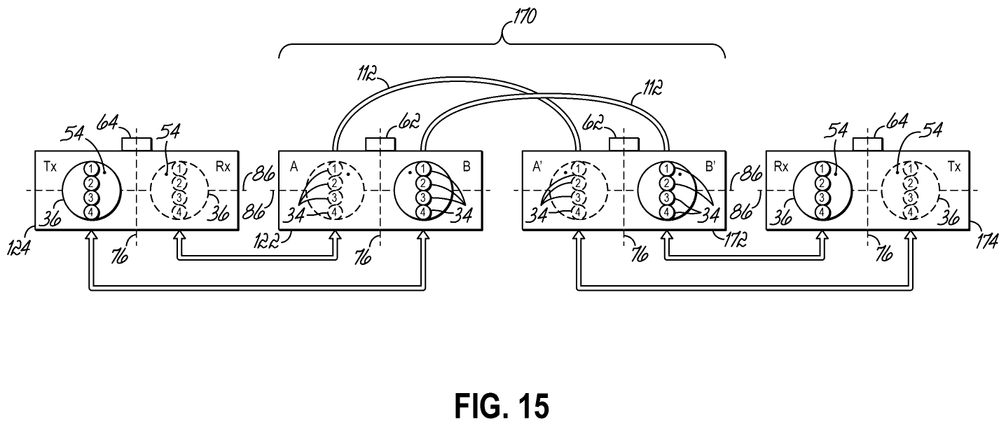

FIGS. 12-16 depict exemplary multicore A-to-A duplex patch cords 140, 150, 160, 170, 180 each corresponding to a respective multicore A-to-B duplex patch cord 70, 80, 110, 120, 130 depicted in FIGS. 6, 7, and 9-11. The components of the A-to-A duplex patch cords 140, 150, 160, 170, 180 have the same configuration as those of their counterpart A-to-B duplex patch cords 70, 80, 110, 120, 130 except for cable connectors 142, 152, 162, 172, 182 and port connectors 144, 154, 164, 174, 184 on the reversed-polarity end of the patch cords 140, 150, 160, 170, 180.

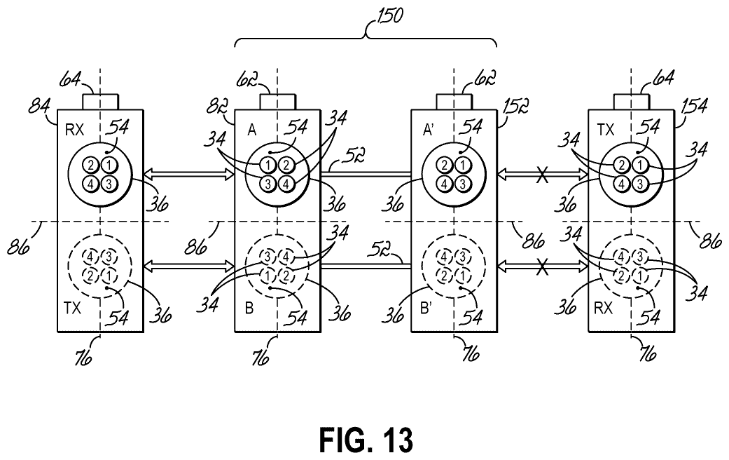

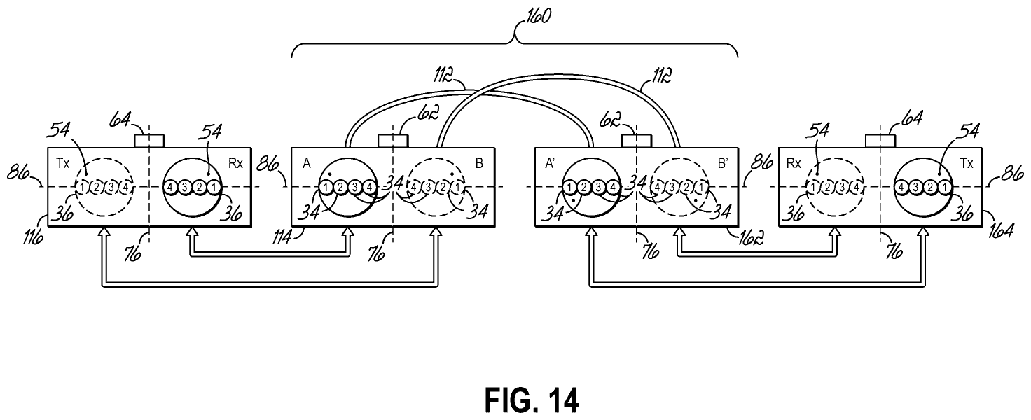

When the connector topologies of A-to-B duplex patch cords 70, 80 of FIGS. 6 and 7 are adapted to the A-to-A duplex patch cords 140, 150 of FIGS. 12 and 13, core polarity is disrupted, as indicated by the “X” through the double-headed arrows. However, when the connector topologies of A-to-B duplex patch cords 110, 120, 130 of FIGS. 10-12 are adapted to the A-to-A duplex patch cords 160, 170, 180 of FIGS. 14-16, core polarity is maintained. This ability to maintain core polarity in both the A-to-A duplex patch cores 160, 170, 180 and the A-to-B duplex patch cords 110, 120, 130 may be attributed to the core pattern of each individual optical fiber 112 having mirror-image symmetry about the direction of the key-axis 76 for each of the duplex patch cords 110, 120, 130, 160, 170, 180. That is, the optical fibers 112 are oriented and positioned within each connector 114, 116, 122, 124, 132, 134, 162, 164, 172, 174, 182, 184 of the duplex patch cords 110, 120, 130, 160, 170, 180 so that the core pattern of each optical fiber 112 has mirror-image symmetry about a line of symmetry parallel to the key-axis 76. Although the marker 54 provides an indication of the mirror-image reversal of the fiber end faces, the core patterns themselves are unchanged by this reversal. Thus, the configurations depicted by FIGS. 9, 10, 11, 14, 15, and 16 support both straight-though and cross-over connectivity in duplex patch cords.

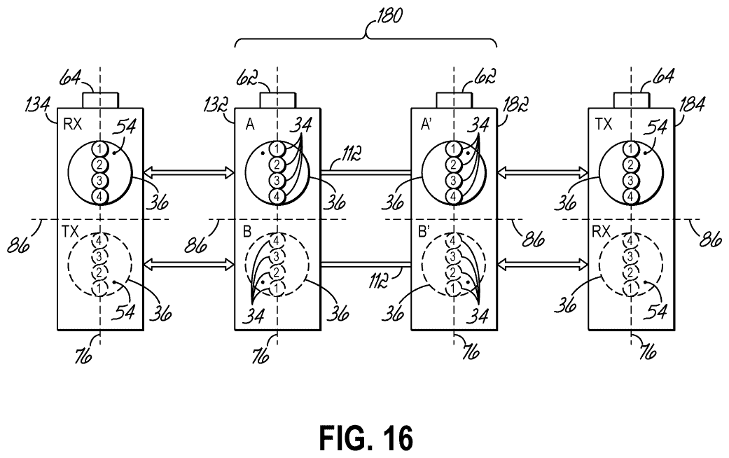

The 1×4 multicore optical fiber may be used, for example, with VSFF dual-ferrule connectors. The connector core pattern of patch cords 130, 180 (FIGS. 11 and 16) has mirror-image symmetry along both the key-axis 76 and cross-axis 86, which may be advantageous. The mirror image symmetry along the key-axis 76 of patch cords 130, 180 is due to the symmetric nature of the core pattern of each optical fiber 112. The mirror image symmetry along the cross-axis 86 is due to the anti-parallel-configuration of the multicore optical fibers 112. Thus, a two-dimensional mirror-image symmetry can be achieved by combining these individual mirror image symmetries, e.g., by orienting the end faces 36 of the multicore optical fibers 112 in the connector interface 42 so that these mirror-image symmetries are orthogonal to each other. As a result, the cores 34 in the two multicore optical fibers 112 may be modified to switch fiber polarity by simply moving the alignment key 62 of connector 132 to the opposite side of the connector housing.

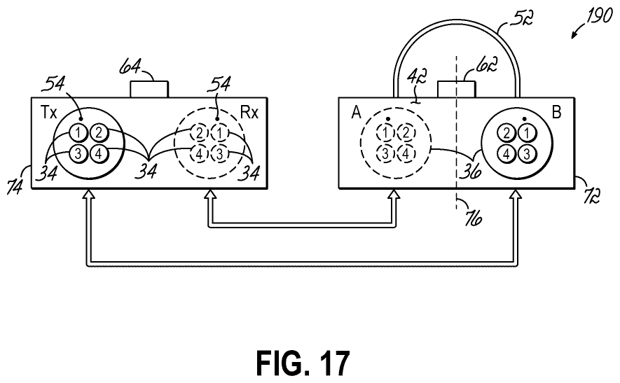

FIG. 17 depicts an exemplary multicore optical fiber loopback device 190. The connector interface 42 of loopback device 190 maintains a mirror-image symmetry between the core patterns of the end faces 36 about the key-axis 76. The loopback device 190 includes a single multicore optical fiber 52 having both end faces 36 terminated by the same connector 72. Loopback devices are commonly used for transceiver testing.

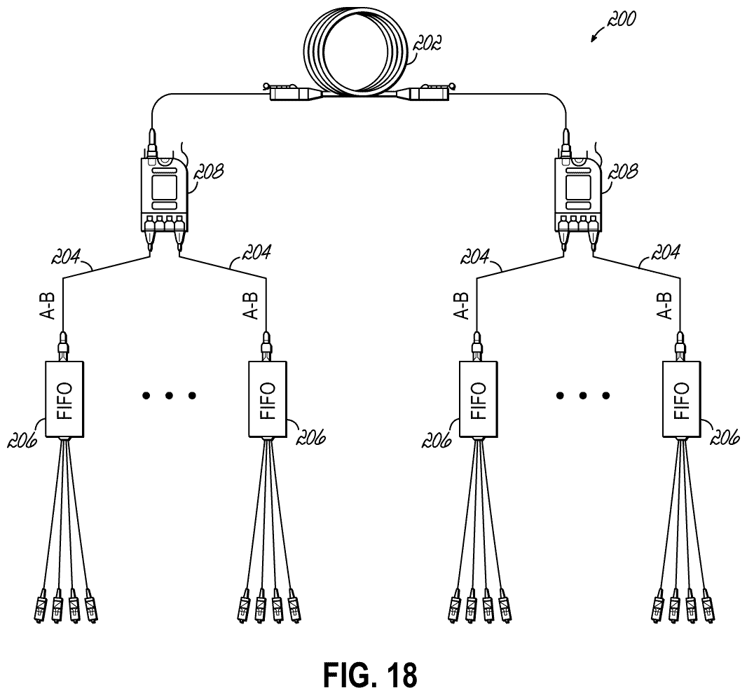

FIG. 18 depicts an exemplary structured cabling system 200 for interconnecting two sets of transceivers (not shown) through a trunk cable 202. The structured cabling system 200 includes a plurality of A-to-B duplex patch cords 204 that operatively couple fan-in/fan-out devices 206 to breakout cassettes/modules 208. The breakout cassettes 208 operatively couple one end of each A-to-B duplex patch cord 204 to the trunk cable 202. With a 4-core multicore optical fiber, a parallel single mode transceiver may only require a duplex interface. Alternatively, four Coarse Wavelength Division Multiplexing (CWDM) transceivers can share a single duplex interface. Advantageously, existing structured cabling hardware may be used to implement multicore optical fiber based connectivity.

In an alternative embodiment, the breakout cassettes 208 and A-to-B duplex patch cords 204 may be replaced by breakout harnesses. As demonstrated by the structured cabling system 200 of FIG. 18, A-to-B duplex patch cords 204 are fundamental building blocks for many structured cabling systems. Without the two-way connectivity provided by the A-to-B duplex patch cords 204, the cabling system 200 would require two different types of duplex interfaces for transceivers and cassettes. The resulting duplex patch cord would therefore require a dedicated connector for each interface. This would be difficult to manage, resulting in increased component and maintenance costs.

It should be understood that there are many possible variations of the above exemplary embodiments. The multicore optical fibers may also have other numbers of cores and different core configurations. For example, 8-core optical fibers may be suitable for a next generation 8-lane parallel single mode transceivers. Multicore optical fibers with different numbers of cores may also be used for combining the fibers from Coarse Wavelength Division Multiplexing (CWDM) transceivers. Thus, the use of anti-parallel multicore optical fiber with properly oriented mirror-image symmetry in duplex core patterns may be applied to any type of duplex connector.

It should be further understood that many different core patterns and configurations of multicore optical fibers may be used to produce a connector having a connector core pattern with mirror-image symmetry. Moreover, although the exemplary connectors described above are generally depicted as having 1×2 connectors for purposes of clarity, aspects of the present disclosure are not limited to this configuration. For example, connectors may be expanded vertically by stacking arrangements of multicore optical fibers similar to those depicted herein, or horizontally by ganging arrangements of multicore optical fibers similar to those depicted herein.

Typically, connectors having mirror-image symmetry will have an even number of multicore optical fibers. However, an odd number of multicore optical fibers may be used if the core pattern of a center fiber itself has mirror-image symmetry. Although the above examples are connectors having between two and four multicore optical fibers, there is no specific limit to the number of multicore optical fibers that can be assembled into a cable assembly. The multicore optical fibers may also have different numbers of cores and cores arranged in different patterns than shown. For example, cores may be arranged in patterns that have radial symmetry or that lack radial symmetry. Reference cores may be indicated by a marker embedded in the multicore optical fiber, or may be indicated by being in an off normal position.

Advantageously, the cost of manufacturing cable assemblies having multicore optical fibers with mirror-image symmetry should not be significantly higher than for conventional fiber optic cable assemblies that have single core optical fibers. The same manufacturing processes may be used to make the cable assemblies despite the different optical fibers (i.e., multicore instead of single core). To form the desired pattern of anti-parallel multicore optical fibers, the end face of the multicore optical fiber on each fiber reel may be inspected to determine the draw direction, e.g., by observing the orientation of the core patterns.

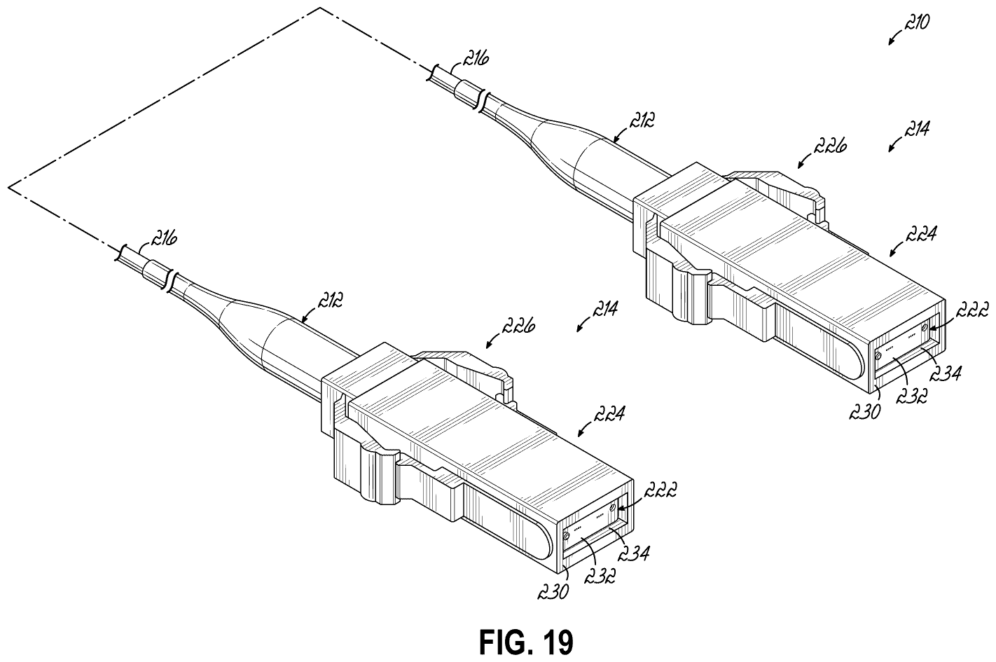

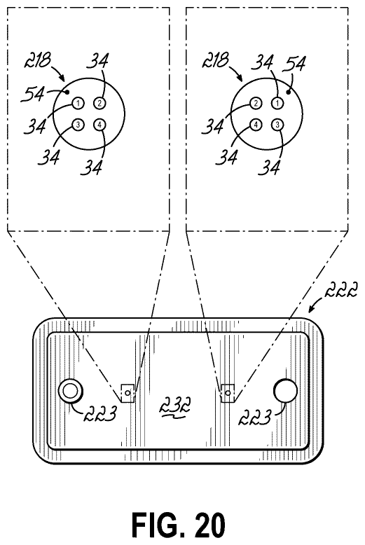

FIGS. 19 and 20 depict an exemplary fiber optic cable assembly 210 that includes a fiber optic cable 212 terminated at each end by a respective fiber optic connector 214. The fiber optic cable 212 also includes an outer jacket 216 that surrounds and protects a plurality of optical fibers 218. The connector 214 is shown with a particular configuration for a multi-fiber connector, but the fiber optic cable assembly 210 may alternatively include other connector designs, such as MPO-type connectors (e.g., according to IEC 61754-7-3:2019), for example. While the fiber optic cable assembly 210 is illustrated as including one connector 214 at each end thereof, it should be realized that the fiber optic cable 212 may include a large number of optical fibers and be terminated by multiple connectors 214. Thus, aspects of the present disclosure are not limited to the particular cable 212 and connectors 214 shown and described herein.

Each connector 214 may include a ferrule 222 having one or more guide holes 223 and configured to support the optical fibers 218, a housing 224 having a cavity in which the ferrule 222 is received, and a connector body 226 configured to support the fiber optic cable 212 and retain the ferrule 222 within the housing 224. The ferrule 222 may be biased to a forward position within the housing 224 by a spring (not shown). The housing 224 and the connector body 226 may be coupled together, such as through a snap fit or the like, to capture the ferrule 222 within the housing 224. The construction and interoperability between the various parts of connectors 214 are generally known to persons of ordinary skill in optical connectivity and thus will not described further herein. It should be understood that aspects of the disclosure are not limited to the particular shape, size, and configuration of the ferrule or housing shown and described herein but are applicable to a wide range of ferrule and housing configurations.

As best shown by FIG. 20, the multi-core optical fibers 218 may be arranged in the ferrule 222 so that they collectively define a pattern of cores 34 across the end face 232 of ferrule 222 which has mirror-image symmetry. In the exemplary embodiment depicted, this symmetry is achieved by the multicore optical fiber 218 on one side of the ferrule 222 having one draw direction, and the multicore optical fiber 218 on the other side of the ferrule having another draw direction opposite that of the other draw direction. That is, the multicore optical fiber 218 on the one side of the ferrule is anti-parallel to the multicore optical fiber 218 on the other side of the ferrule 222.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A fiber optic cable assembly, comprising:
a first connector defining a first end of the fiber optic cable assembly and including a first connector interface having a first interface axis of symmetry;
a second connector defining a second end of the fiber optic cable assembly and including a second connector interface having a second interface axis of symmetry;
a first multicore optical fiber including a first front end face having a front end face core pattern and a first back end face having a back end face core pattern that is a mirror-image of the front end face core pattern; and
a second multicore optical fiber including a second front end face having the front end face core pattern and a second back end face having the back end face core pattern, wherein:
the first connector is configured so that the first front end face of the first multicore optical fiber and the second back end face of the second multicore optical fiber are placed in the first connector interface to define, at least in part, a first connector core pattern having mirror-image symmetry about the first interface axis of symmetry, and
the second connector is configured so that the first back end face of the first multicore optical fiber and the second front end face of the second multicore optical fiber are each placed in the second connector interface to define, at least in part, a second connector core pattern having mirror-image symmetry about the second interface axis of symmetry;
wherein the first connector core pattern and the second connector core pattern are the same.

2. The fiber optic cable assembly of claim 1, wherein:
the first connector includes a first alignment key that defines an orientation of the first connector, and
the second connector includes a second alignment key that defines the orientation of the second connector.

3. The fiber optic cable assembly of claim 2, wherein:
the first connector interface includes a first key-axis that is aligned with the first alignment key,
the second connector interface includes a second key-axis that is aligned with the second alignment key,
the first interface axis of symmetry is parallel to the first key-axis, and
the second interface axis of symmetry is parallel to the second key-axis.

4. The fiber optic cable assembly of claim 2, wherein:
the first connector interface includes a first key-axis that is aligned with the first alignment key,
the second connector interface includes a second key-axis that is aligned with the second alignment key,
the first interface axis of symmetry is orthogonal to the first key-axis, and
the second interface axis of symmetry is orthogonal to the second key-axis.

5. The fiber optic cable assembly of claim 1, wherein:
the front end face core pattern has mirror-image symmetry about a fiber axis of symmetry in each of the first front end face and the second front end face, and
the back end face core pattern has mirror-image symmetry about the fiber axis of symmetry in each of the first back end face and the second back end face.

6. The fiber optic cable assembly of claim 5, wherein:
the first interface axis of symmetry divides the first connector interface into a first side and a second side thereof,
the second interface axis of symmetry divides the second connector interface into a first side and a second side thereof,
the first side of the first connector interface has the same position relative to the first interface axis of symmetry as the first side of the second connector interface has relative to the second interface axis of symmetry,
the second side of the first connector interface has the same position relative to the first interface axis of symmetry as the second side of the second connector interface has relative to the second interface axis of symmetry,
the first front end face of the first multicore optical fiber is on the first side of the first connector interface,
the second back end face of the second multicore optical fiber is on the second side of the first connector interface,
the first back end face of the first multicore optical fiber is on the second side of the second connector interface, and
the second front end face of the second multicore optical fiber is on the first side of the second connector interface.

7. The fiber optic cable assembly of claim 5, wherein:
the first interface axis of symmetry divides the first connector interface into a first side and a second side thereof,
the second interface axis of symmetry divides the second connector interface into a first side and a second side thereof,
the first side of the first connector interface has the same position relative to the first interface axis of symmetry as the first side of the second connector interface has relative to the second interface axis of symmetry,
the second side of the first connector interface has the same position relative to the first interface axis of symmetry as the second side of the second connector interface has relative to the second interface axis of symmetry,
the first front end face of the first multicore optical fiber is on the first side of the first connector interface,
the second back end face of the second multicore optical fiber is on the second side of the first connector interface,
the first back end face of the first multicore optical fiber is on the first side of the second connector interface, and
the second front end face of the second multicore optical fiber is on the second side of the second connector interface.

8. The fiber optic cable assembly of claim 5, wherein:
the fiber axis of symmetry of each of the first front end face and the second back end face is orthogonal to the first interface axis of symmetry, and
the fiber axis of symmetry of each of the first back end face and the second front end face is orthogonal to the second interface axis of symmetry.

9. The fiber optic cable assembly of claim 5, wherein:
the fiber axis of symmetry of each of the first front end face and the second back end face is parallel to the first interface axis of symmetry, and
the fiber axis of symmetry of each of the first back end face and the second front end face is parallel to the second interface axis of symmetry.

10. A method of making a fiber optic cable assembly, comprising:
providing a first multicore optical fiber including a first front end and a first back end, the first front end including a first front end face having a front end face core pattern, and the first back end including a first back end face having a back end face core pattern that is a mirror image of the front end face core pattern;
providing a second multicore optical fiber including a second front end and a second back end, the second front end including a second front end face having the front end face core pattern and the second back end including a second back end face having the back end face core pattern;
coupling the first front end of the first multicore optical fiber and the second back end of the second multicore optical fiber to a first connector, the first connector including a first connector interface having a first interface axis of symmetry;
coupling the first back end of the first multicore optical fiber and the second front end of the second multicore optical fiber to a second connector, the second connector including a second connector interface having a second interface axis of symmetry;
placing the first front end face of the first multicore optical fiber and the second back end face of the second multicore optical fiber in the first connector interface to define, at least in part, a first connector core pattern having mirror-image symmetry about the first interface axis of symmetry; and
placing the first back end face of the first multicore optical fiber and the second front end face of the second multicore optical fiber in the second connector interface to define, at least in part, a second connector core pattern having mirror-image symmetry about the second interface axis of symmetry,
wherein the first connector core pattern and the second connector core pattern are the same.

11. The method of claim 10, further comprising:
providing a first alignment key to the first connector that defines an orientation of the first connector, and
providing a second alignment key to the second connector that defines the orientation of the second connector.

12. The method of claim 11, further comprising:
defining a first key-axis of the first connector interface that is aligned with the first alignment key; and
defining a second key-axis of the second connector interface that is aligned with the second alignment key, wherein
the first interface axis of symmetry is parallel to the first key-axis, and
the second interface axis of symmetry is parallel to the second key axis.

13. The method of claim 11, further comprising:
defining a first key-axis of the first connector interface that is aligned with the first alignment key; and
defining a second key-axis of the second connector interface that is aligned with the second alignment key, wherein
the first interface axis of symmetry is orthogonal to the first key-axis, and
the second interface axis of symmetry is orthogonal to the second key axis.

14. The method of claim 10, further comprising:
configuring the first and second multicore optical fibers so that the front end face core pattern has mirror-image symmetry about a fiber axis of symmetry in each of the first front end face and the second front end face, and the back end face core pattern has mirror-image symmetry about the fiber axis of symmetry in each of the first back end face and the second back end face.

15. The method of claim 14, wherein the first interface axis of symmetry divides the first connector interface into a first side and a second side thereof, the second interface axis of symmetry divides the second connector interface into a first side and a second side thereof, the first side of the first connector interface has the same position relative to the first interface axis of symmetry as the first side of the second connector interface has relative to the second interface axis of symmetry, the second side of the first connector interface has the same position relative to the first interface axis of symmetry as the second side of the second connector interface has relative to the second interface axis of symmetry, and further comprising:
placing the first front end face of the first multicore optical fiber in the first connector interface so that the first front end face is on the first side of the first connector interface,
placing the second back end face of the second multicore optical fiber in the first connector interface so that the second back end face is on the second side of the first connector interface,
placing the first back end face of the first multicore optical fiber in the second connector interface so that the first back end face is on the second side of the second connector interface, and
placing the second front end face of the second multicore optical fiber in the second connector interface so that the second front end face is on the first side of the second connector interface.

16. The method of claim 14, wherein the first interface axis of symmetry divides the first connector interface into a first side and a second side thereof, the second interface axis of symmetry divides the second connector interface into a first side and a second side thereof, the first side of the first connector interface has the same position relative to the first interface axis of symmetry as the first side of the second connector interface has relative to the second interface axis of symmetry, the second side of the first connector interface has the same position relative to the first interface axis of symmetry as the second side of the second connector interface has relative to the second interface axis of symmetry, and further comprising:
placing the first front end face of the first multicore optical fiber in the first connector interface so that the first front end face is on the first side of the first connector interface,
placing the second back end face of the second multicore optical fiber in the first connector interface so that the second back end face is on the second side of the first connector interface,
placing the first back end face of the first multicore optical fiber in the second connector interface so that the first back end face is on the first side of the second connector interface, and
placing the second front end face of the second multicore optical fiber in the second connector interface so that the second front end face is on the second side of the second connector interface.

17. The method of claim 14, further comprising:
placing each of the first front end face and the second back end face in the first connector interface so that the fiber axis of symmetry of each of the first front end face and the second back end face is orthogonal to the first interface axis of symmetry, and
placing each of the first back end face and the second front end face in the second connector interface so that the fiber axis of symmetry of each of the first back end face and the second front end face is orthogonal to the second interface axis of symmetry.

18. The method of claim 14, further comprising:
placing each of the first front end face and the second back end face in the first connector interface so that the fiber axis of symmetry of each of the first front end face and the second back end face is parallel to the first interface axis of symmetry, and
placing each of the first back end face and the second front end face in the second connector interface so that the fiber axis of symmetry of each of the first back end face and the second front end face is parallel to the second interface axis of symmetry.

19. A fiber optic connector, comprising:
a connector interface including an interface axis of symmetry;
a front end face of a first multicore optical fiber including a front end face core pattern; and
a back end face of a second multicore optical fiber including a back end face core pattern that is a mirror image of the front end face core pattern, wherein:
the front end face of the first multicore optical fiber and the back end face of the second multicore optical fiber are placed in the connector interface so that the front end face and the second back end face define, at least in part, a connector core pattern having mirror-image symmetry about the interface axis of symmetry.

20. The fiber optic connector of claim 19, wherein:
the front end face core pattern has mirror-image symmetry about a fiber axis of symmetry of the front end face, and
the back end face core pattern has mirror-image symmetry about the fiber axis of symmetry back end face.
